(19) United States
(12) Patent Application Publication
(10) Pub. No.: US 2023/0005629 A1
(43) Pub. Date: Jan. 5, 2023

(54) SYSTEM FOR CONFINING AND COOLING MELT FROM THE CORE OF A NUCLEAR REACTOR

(71) Applicants: JOINT-STOCK COMPANY "ATOMENERGOPROEKT", Mosow (RU); SCIENCE AND INNOVATIONS-NUCLEAR INDUSTRY SCIENTIFIC DEVELOPMENT, PRIVATE ENTERPRISE, Moscow (RU)

(72) Inventors: ALEKSANDR STALEVICH SIDOROV, Moscow (RU); TATYANA YAROPOLKOVNA DZBANOVSKAYA, Moscow (RU); INNA SERGEEVNA SIDOROVA, Moscow (RU)

(73) Assignees: JOINT-STOCK COMPANY "ATOMENERGOPROEKT", Moscow (RU); SCIENCE AND INNOVATIONS-NUCLEAR INDUSTRY SCIENTIFIC DEVELOPMENT, PRIVATE ENTERPRISE, Moscow (RU)

(21) Appl. No.: 17/619,123

(22) PCT Filed: Dec. 29, 2020
(86) PCT No.: PCT/RU2020/000764

§ 371 Date: Dec. 15, 2021

(30) Foreign Application Priority Data
Mar. 20, 2020 (RU) 2020111692

(51) Int. Cl. G21C 15/18

(52) U.S. Cl. CPC G21C 15/18

(57) ABSTRACT

The invention relates to the field of nuclear energy, in particular, to systems that ensure the safety of nuclear power plants (NPP), and can be used in severe accidents that lead to reactor pressure vessel and its containment destruction.

The technical result of the claimed invention consists in increasing the reliability of the corium localizing and cooling system of a nuclear reactor, increase of heat removal efficiency from corium of a nuclear reactor.

The technical result is achieved by using the membraned, drum and thermal protection installed in the area between the layered vessel and cantilever truss in the corium localizing and cooling system of a nuclear reactor.

### TECHNICAL FIELD OF THE INVENTION

The invention relates to the field of nuclear energy, in particular, to systems that ensure the safety of nuclear power plants (NPP), and can be used in severe accidents that lead to reactor pressure vessel and its containment destruction.

The accidents with core meltdown, which may take place during multiple failure of the core cooling system, constitute the greatest radiation hazard.

During such accidents the core melt—corium—by melting the core structures and reactor pressure vessel escapes outside its limits, and the afterheat retained in it may disturb the integrity of the NPP containment—the last barrier in the escape routes of radioactive products to the environment.

To exclude this, it is required to localize the core melt (corium) escaping from the reactor pressure vessel and provide its continuous cooling up to its complete crystallization. The corium localizing and cooling system of a nuclear reactor performs this function, which prevents the damage of the NPP containment and thereby protects the public and environment against exposure effect during severe accidents of nuclear reactors.

### PRIOR ART

The corium localizing and cooling system of a nuclear reactor containing the guide plate installed below the reactor pressure vessel, and resting upon the cantilever truss, installed in the embedded parts in the concrete well foundation of the layered vessel, flange thereof is provided with thermal protection, filler installed inside the layered vessel consisting of a set of cassettes installed in one another.

This system in accordance with its design features has the following disadvantages, namely:
at the time of reactor pressure vessel melt-through (destruction) by corium in the formed hole by the action of residual pressure in the reactor pressure vessel, the melt begins to outflow and gases which are released inside the space of the layered vessel and inside the peripheral spaces located between the layered vessel, filler and cantilever truss are vented, gas pressure is quickly increased in these spaces following which the destruction of the corium localizing and cooling system in the welding zone of the layered vessel with the cantilever truss may take place;
on inflow of corium inside the layered vessel, the cantilever truss and layered vessel following heating up, impact or earthquake actions may independently displace with respect to each other that may lead to the destruction of their leak-tight joint, and thus malfunction of the corium localizing and cooling system.

The corium localizing and cooling system [2] of a nuclear reactor containing the guide plate installed under the reactor pressure vessel and resting upon the cantilever truss installed in the embedded parts in the concrete well foundation of the layered vessel, flange thereof is provided with thermal protection, filler installed inside the layered vessel consisting of a set of cassettes installed in one another is known.

This system in accordance with its design features has the following disadvantages, namely:
at the time of reactor pressure vessel melt-through (destruction) by corium in the formed hole by the action of residual pressure in the reactor pressure vessel, the melt begins to outflow and gases which are released inside the space of the layered vessel and inside the peripheral spaces located between the layered vessel, filler and cantilever truss are vented, gas pressure is quickly increased in these spaces following which the destruction of the corium localizing and cooling system in the welding zone of the layered vessel with the cantilever truss may take place;
on inflow of corium inside the layered vessel, the cantilever truss and layered vessel following heating up, impact or earthquake actions may independently displace with respect to each other that may lead to the destruction of their leak-tight joint, and thus malfunction of the corium localizing and cooling system.

The corium localizing and cooling system [3] of a nuclear reactor containing the guide plate installed under the reactor pressure vessel and resting upon the cantilever truss installed in the embedded parts in the concrete well foundation of the layered vessel, flange thereof is provided with thermal protection, filler installed inside the layered vessel consisting of a set of cassettes installed in one another, each of them comprises one central and several peripheral holes, water supply valves, installed in the branch pipes located along the perimeter of the layered vessel in the area between the upper cassette and flange is known.

This system in accordance with its design features has the following disadvantages, namely:
at the time of reactor pressure vessel melt-through (destruction) by corium in the formed hole by the action of residual pressure in the reactor pressure vessel, the melt begins to outflow and gases which are released inside the space of the layered vessel and inside the peripheral spaces located between the layered vessel, filler and cantilever truss are vented, gas pressure is quickly increased in these spaces following which the destruction of the corium localizing and cooling system in the welding zone of the layered vessel with the cantilever truss may take place;
on inflow of corium inside the layered vessel, the cantilever truss and layered vessel following heating up, impact or earthquake actions may independently displace with respect to each other that may lead to the destruction of their leak-tight joint, and thus malfunction of the corium localizing and cooling system.

### DISCLOSURE OF THE INVENTION

The technical result of the claimed invention consists in increasing the reliability of the corium localizing and cooling system of a nuclear reactor, increase of heat removal efficiency from corium of a nuclear reactor.

The tasks for resolving thereof the claimed invention is directed are the following:
providing pressurization of the layered vessel against flooding by water input for cooling of the external surface of the layered vessel;
providing independent radial and azimuthal heat expansions of the cantilever truss;
providing independent displacements of the cantilever truss and layered vessel during earthquake and impact mechanical actions on the equipment elements of the corium localizing and cooling system;
providing reduction of thermal and mechanical and dynamic loads on the membrane;
improving the external cooling conditions of the layered vessel, including its thick walled flange;
improving the membrane actuation conditions as passive protection against overheat during non-availability or shortage of cooling of the internal space of the layered vessel;
providing maximum hydraulic resistance during movement of the gas-vapor mixture from the inner space of the layered vessel to the space located in the area between the layered vessel and cantilever truss;

The assigned tasks are resolved based on the fact that in the corium localizing and cooling system of a nuclear reactor containing the guide plate (1), installed under the reactor pressure vessel (2) and resting upon the cantilever truss (3) installed on the embedded parts in the foundation of the concrete cavity of the layered vessel (4), designed for intake and distribution of corium, flange (5) thereof is provided with thermal protection (6), filler (7) consisting of several cassettes (8) installed on each other, each of them comprises of one central and several peripheral holes (9), water supply valves (10), installed in the branch pipes (11) located along the perimeter of the layered vessel (4) in the area between the upper cassette (8) and flange (5), in accordance with the invention a drum (34) is installed on the flange (5) of the layered vessel (4), executed in the form of shell (35) with strengthening ribs (36) located along its perimeter, resting upon the cover (37) and head (38), having tensioning elements (30), connecting the drum (34) through the supporting flange (31) welded to it with the flange (5) of the layered vessel (4), a concave membrane (12) is installed on the drum (34), the concave side thereof is turned outside the limits of the layered vessel (4), provided that in the upper part of the concave membrane (12) in the joint area with the lower part of the cantilever truss (3) the elements (13) of the upper heat resistance are executed, connected to each other by welding with formation of contact gap (14), in the lower part of the membrane (12) of concave form in the joint area with the cover (37) of the drum (34) the elements (32) of the lower heat resistance are executed, connected with each other by welding with formation of the lower contact gap (33), inside the layered vessel (4) thermal protection (15) is installed in addition, consisting of the external (21), internal (24) shells and head (22), suspended to the flange (28) of the cantilever truss (3) by heat-proof fasteners (19), installed in the heat-insulating flange (18) with contact wafer gap (29), located between the heat-insulating flange (18) and flange (28) of the cantilever truss (3), and covering the upper part of the thermal protection (6) of the flange (5) of the layered vessel (4), between them in the covering area is the circular coffer (16) with pass through holes (17), in this case the external shell (21) is executed in such manner that its strength is above the strength of the inner shell (24) and head (22), and the space between the external shell (21), head (22) and internal shell (24) if filled with melting concrete (26) divided into sectors by vertical (23), long radial (25) and short radial (27) reinforcement rods.

One of the essential feature of the claimed invention is the availability of a drum in the corium localizing and cooling system of a nuclear reactor installed on the flange of the layered vessel, executed in shell form with strengthening ribs located along its perimeter, resting upon the cover and head, having tensioning elements, connecting the drum through the supporting flange welded to it with the layered vessel flange. The availability of drum as part of the core localizing and cooling system of a nuclear reactor, on increase of the maximum water level on the part of the outer surface of the layered vessel allows provide reduction of thermal and mechanical and dynamic loads on the membrane, improve the conditions of external cooling of the layered vessel, including its thick walled flange, improve the actuation conditions of the membrane as passive protection against overheat during absence or shortage of cooling of the internal space of the layered vessel.

One more essential feature of the claimed invention is the availability of conclave membraned installed in the drum in the corium localizing and cooling system of a nuclear reactor. The concave side of the membrane is turned outside the layered vessel. The elements of the upper heat resistance providing deteriorate conditions of heat transfer have been executed in the upper part of the concave membrane in the joint area with the lower part of the cantilever truss, assisting overheat of the upper part of the membrane and connected with each other by welding with formation of the upper contact gap, assisting the blocking of heat exchange on the membrane side to the cantilever truss and assisting in redirecting the heat flows from the membrane to the cantilever truss through the welded joint, which is overheated and damaged as a result of this process. The elements of the lower heat resistance have been executed in the lower part of the concave membrane in the joint area with the cover of the drum, providing deteriorate condition of heat transfer assisting the overheating of the lower part of the membrane and connected with each other by welding with formation of the lower contact gap, capable of blocking heat exchange on the part of the membrane to the drum and assisting in redirecting the heat flows from the membranes to the drum through the welded joint, which is overheated and destroyed following this process. The availability of membrane as part of the corium localizing and cooling system of a nuclear reactor allows provide pressurization of the layered vessel against flooding with water input for cooling the outer surface of the layered vessel, provide independent radial and azimuthal thermal expansions of the cantilever truss, provide axial and radial thermal expansions of the layered vessel, provide independent movements of the cantilever truss and layered vessel during earthquake and impact mechanical actions on the elements of the core catcher equipment, provide destruction of the membrane during violations of the cooling of internal volumes of the layered vessel and corium.

One more essential feature of the claimed invention is the availability of thermal protection in the corium localizing and cooling system of a nuclear reactor installed inside the layered vessel. Thermal protection consists of external, internal shells and head. Thermal protection is suspended to the cantilever truss flange by heat-proof fasteners, which are installed in the heat-insulating flange with contact wafer gap. The contact wafer gap is located between the heat-insulating flange and the cantilever truss flange. Thermal protection covers the upper part of the thermal protection of layered vessel flange, between them the circular coffer with orifices is installed in the covering area. The external shell of the thermal protection is executed in such manner that its strength is higher than the strength of the internal shell and head, and protective layer of melting concrete divided into sectors by the vertical ribs is applied on the external surface and retained by the vertical long radial and short radial reinforcement rods. The availability of thermal protection withstands direct impact action on the part of the corium and on the part of gas dynamic flows from the reactor pressure vessel to the leak-tight joint area of the layered vessel with the cantilever truss. The circular coffer with orifices by its functional capabilities forms a sort of gas dynamic damper, which allows provide the required pressure drop during movement of gas-vapor mixture from the inner space of the reactor pressure vessel to the space located outside the external thermal protection surface, and reduce the pressure increase rate at the periphery, by simultaneously increasing the time of rise of this pressure that provides the required time for levelling pressure inside and outside the layered vessel.

### BRIEF DESCRIPTION OF DRAWINGS

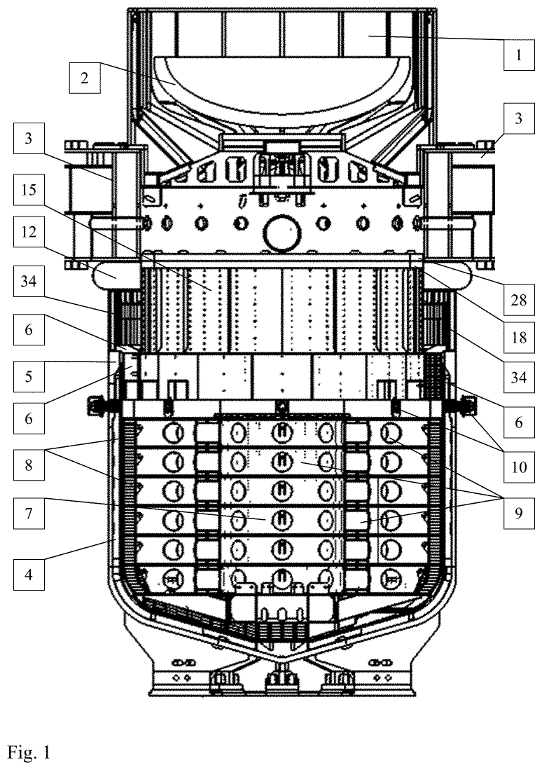

The corium localizing and cooling system of a nuclear reactor executed in accordance with the claimed invention is show in FIG. 1.

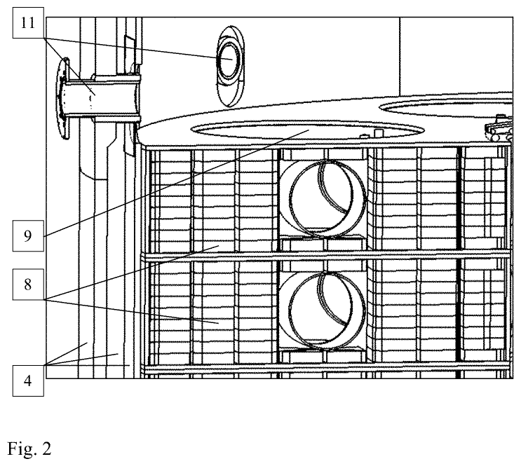

The area between the filler upper cassette and lower surface of the cantilever truss is shown in FIG. 2.

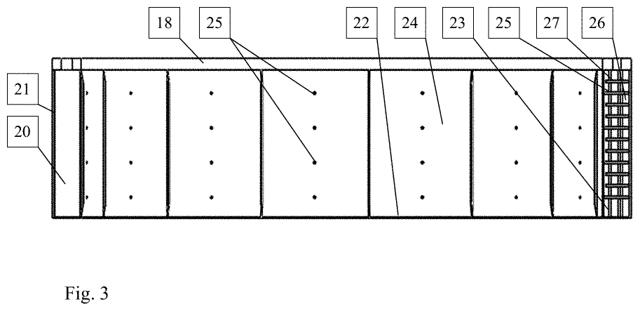

The general view of the thermal protection executed in accordance with the claimed invention is shown in FIG. 3.

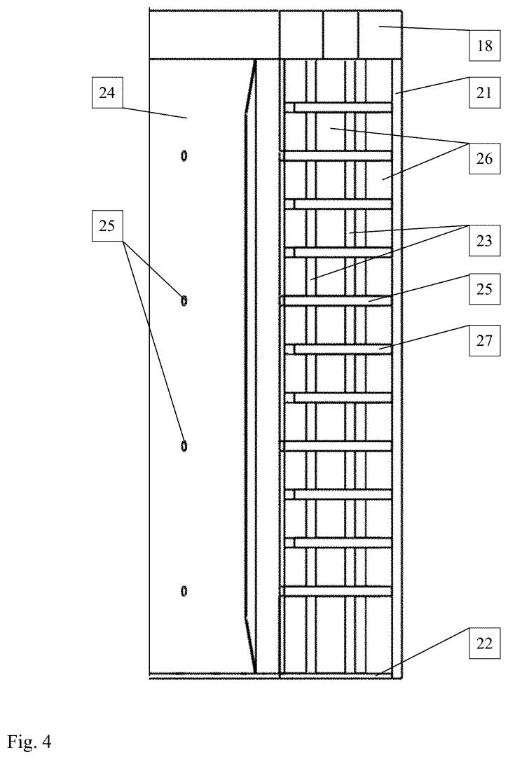

The fragment of thermal protection in section executed in accordance with the claimed invention is shown in FIG. 4.

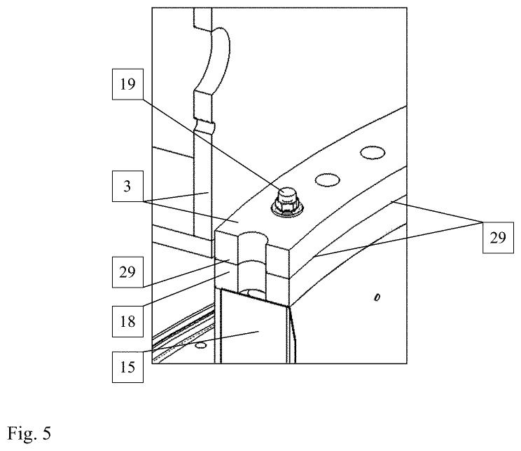

The securing area of the thermal protection to the cantilever truss is shown in FIG. 5.

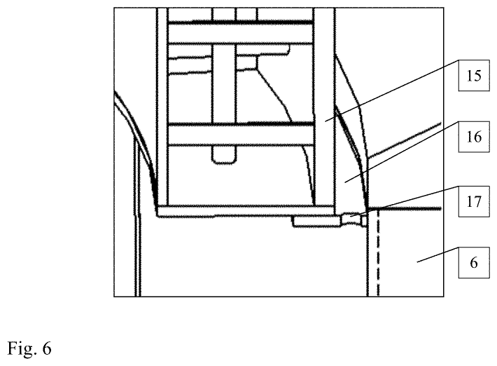

The circular coffer executed in accordance with the claimed invention is shown in FIG. 6.

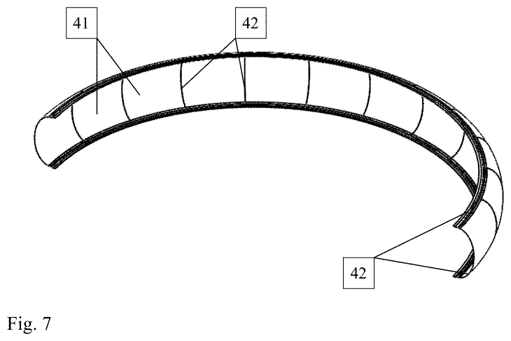

The general view of the membrane, executed in accordance with the claimed invention is shown in FIG. 7.

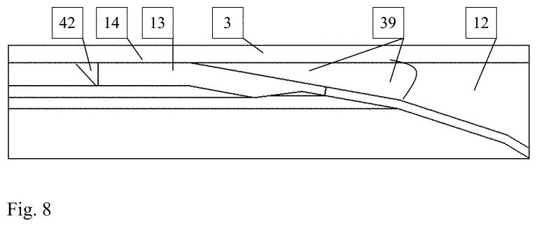

The joining area of the membrane with the lower surface of the cantilever truss is shown in FIG. 8.

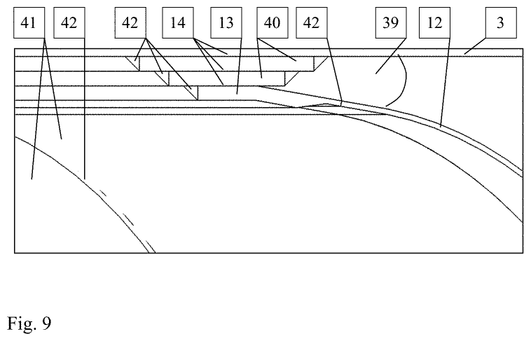

The joining area of the membrane with the lower surface of the cantilever truss executed using additional plates is shown in FIG. 9.

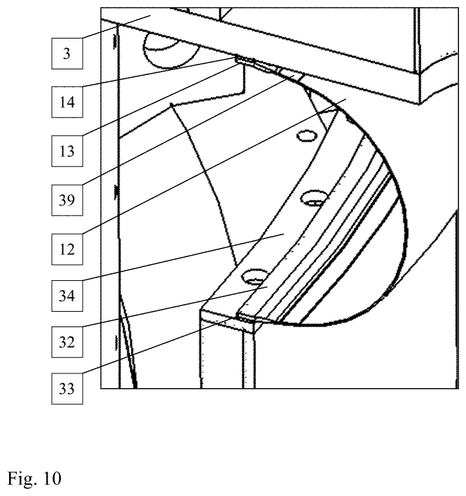

The securing area of the upper part of the membrane with the lower part of the cantilever truss and securing area of the lower part of the membrane with the drum is shown in FIG. 10.

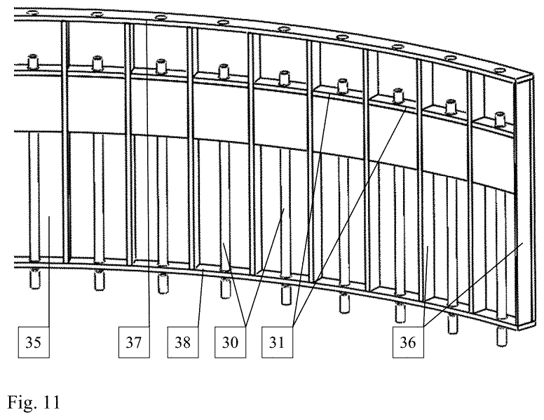

The drum executed in accordance with the claimed invention is shown in FIG. 11.

### EMBODIMENTS OF THE INVENTION

As shown in FIG. 1-11, the corium localizing and cooling system of a nuclear reactor contains the guide plate (1), installed below the reactor pressure vessel (2) and resting upon the cantilever truss (3). The layered vessel (4) designed for intake and distribution of corium is installed below the cantilever truss (3). The layered vessel (4) is installed on embedded parts. The flange (5) of the layered vessel (4) is provided with thermal protection (6). The filler (7), which consists of several cassettes (8) installed on each other is located inside the layered vessel (4). Each cassette (8) has one central and several peripheral orifices (9). The water supply valves (10) are installed in the branch pipes (11) located along the perimeter of the layered vessel (4) in the area between the upper cassette (8) and flange (5). The drum (34) executed in the form of shell (35) is installed on the flange (5) of the layered vessel. The strengthening ribs (36), which rest upon the cover (37) and head (38) are located along the perimeter of the shell (35). Moreover the shell (35) has tensioning elements (30). By means of the tensioning elements (30) the drum (34) through the supporting flange (35) welded to it is connected with the flange (5) of the layered vessel (4).

The concave membrane (12) is installed in the drum (34). The concave side of the membrane (34) is turned outside the layered vessel (4). The upper heat resistance elements (13) joined by welding to each other with the formation of upper contact gap (14) are executed in the upper part of the dish membrane (12) in the weld zone with the lower part of the cantilever truss (3). The elements (32) of the lower heat resistance, joined to each other by welding with the formation of lower contact gap (33) are executed in the lower part of the dish membrane (12) in the weld zone with the drum (34) cover (37).

Thermal protection (15) is installed inside the layered vessel (4). Thermal protection (15) consists of the external shell (21), internal shell (24) and head (22). Thermal protection (15) is suspended to the flange (28) of the cantilever truss (3) by heat-resistant fasteners (19), installed in the heat-insulating flange (18) with contact wafer gap (29) located between the heat-insulating flange (18) and flange (28) of the cantilever truss. Thermal protection (15) is installed in such manner that it covers the upper part of the thermal protection (6) of flange (5) of the layered vessel (4), with the circular coffer (16) with orifices (17) installed between them in the overlapping area.

The outer shell (21) is executed in such manner that its strength is above the strength of the inner shell (24) and head (22). The space between the outer shell (21), head (22) and inner shell (24) is filled with melting concrete (26). The melting concrete (26) is divided into sectors by vertical ribs (20), long radial (25) and short radial (27) reinforcement rods.

The claimed corium localizing and cooling system of a nuclear reactor according to the claimed invention operates as follows.

At the time of reactor pressure vessel (2) destruction corium under the action of hydrostatic and excess pressures begins to enter the guide plate (1) surface held down by the cantilever truss (3). The melt, running down along the guide plate (1) enters the layered vessel (4) and enters into contact with the filler (7). During sectoral nonaxisymmetrical melt trickling the thermal protections (6) and (15) are bonded. By disintegrating these thermal protections on the one part reduce thermal action of corium on the protected equipment, on the other part reduce the temperature and chemical activity of the melt itself.

Thermal protection (6) of the flange (5) of the layered vessel (4) provides protection of its upper thick-walled internal part against thermal action on the part of the corium mirror from the time of melt intake into the filler (7) and to the end of interaction of melt with the filler (7), i.e. to the start time of cooling of the clinker located on the corium surface with water. The thermal protection (6) of the flange (5) of the multi-layered vessel (4) is installed in such manner that allows provide protection of the internal surface of the multi-layered vessel (4) above the corium level formed in the layered vessel 94) in the interaction process with the filler (7), in particular by that upper part of the layered vessel (4) providing normal (without heat exchange crisis in boiling mode in large quantity) heat transfer from corium to water present on the external side of the layered vessel (4).

The thermal protection (6) of the flange (5) of the layered vessel (4) in the process of interaction of the corium with the filler (7) is subject to heating and partial disintegration, by shielding heat insulation on the part of melt mirror. The geometrical and thermal and physical characteristics of thermal protection (6) of the flange (5) of the layered vessel (4) are selected in such manner that at any conditions shielding of the flange (5) of the layered vessel (4) is provided on the part of corium mirror thanks to which in turn the independence of protective functions from completion time of the physical and chemical interaction processes of corium with the filler (78) is provided. Thus, the availability of thermal protection (6) of the flange 95) of the layered vessel (4) allows provide perform the protective functions before the start of water supply to the crust located on the corium surface.

As shown in FIG. 1, 11, the drum (34) executed in the form of shell (35) is installed on the flange (5) of the layered vessel (4). The strengthening ribs (36), which rest upon the cover (37) and head (38) are located along the perimeter of the shell (35). Moreover the shell (35) has tensioning elements (30). By means of the tensioning elements (30) the drum (34) through the supporting flange (35) welded to it is connected with the flange (5) of the layered vessel (4).

The availability of the drum (34) as part of the corium localizing and cooling system of a nuclear reactor on increase of the maximum water level on the part of outer surface of the layered vessel (4) allows provide reduction of the thermal and mechanical and dynamic loads on the membrane (12), improve the outer cooling condition of the layered vessel (4), including its thick walled flange (5), improve the conditions of membrane (12) actuation as passive protection against overheat if there is no or insufficient cooling of the internal space of the layered vessel (4).

The tensioning elements (30) joining the drum (34) with the flange (5) of the layered vessel (4) provide stability of the drum (34) to impact disturbances acting on the part of the inner space of the layered vessel (4), for example, during local pressure increases, earthquake or impact non-axisymmetrical action. In these conditions the tensioning elements (30) through the supporting flange (31) welded to the drum (34) create compressive force, acting on the drum (34) and not allowing it to displace with respect to the flange (5) of the layered vessel (4) during impact disturbances, providing integrity of the leak-tight welded joints of both the membrane (12) and the drum itself (34).

As shown in FIG. 1, 7, 8, 9, 10, the dish membrane (12) is installed on the drum (34), the convex part thereof is turned outside the limits of the layered vessel (4), moreover the elements 913) of the upper thermal resistance providing deterioration of the heat transfer conditions are executed in the upper part of the dish membrane (12) in the joining area with the lower part of the cantilever truss (3), facilitating overheating of the upper part of the membrane and joined with each other by welding with the formation of the upper contact gap (14). The elements (32) of the lower heat resistance providing deteriorated heat transfer conditions are executed in the lower part of the dish membrane (12) in the joining area with the drum (34) cover (37), facilitating overheating of the lower part of the membrane and joined with each other by welding with formation of lower contact gap (33), facilitating the blocking of heat exchange on the part of the membrane to the drum and facilitating redirection of the heat flows from the membrane to the drum through the welded joint, which is overheated and deteriorated following this process.

The membrane (12) provides independent radial and azimuthal thermal expansions of the cantilever truss (3) and axial and radial thermal expansions of the layered vessel (4), provided independent displacements of the cantilever truss 93) and layered vessel (4) during earthquake and impact mechanical actions on the equipment elements of the corium localizing and cooling system of a nuclear reactor.

The membrane (12) is placed in a protected space formed by thermal protection (6) of the flange (5) of the layered vessel (4) and thermal protection (15) suspended to the cantilever truss (3) in order for the membrane (12) to retain its functions at the initial stage of corium intake from the reactor pressure vessel (2) to the layered vessel (4) and pressure increased related to it.

After the start of cooling water intake inside the layered vessel (4), the membrane (12) continues to perform its pressurization functions of the internal space of the layered vessel (4) and dividing the inner and outer media on the cake located on the melt surface. The membrane (12) is not destroyed, cooled by water on the outer side, in condition of stable water cooling of the outer surface of the layered vessel (4).

Gradual destruction of thermal protection (6) of the flange (5) of the layered vessel (4) and thermal protection (15) takes place on failure of cooling water supply inside the layered vessel (4) on, the cake, and the overlap area of thermal protections (15 and 6) gradually reduces to the complete destruction of the overlap area. From this moment the action of heat radiation on the membrane (12) begins on the part of the corium mirror. The membrane (12) begins to get heated on the inner side, however, due to small thickness, the radiant heat flow cannot provide damage of membrane (12), if the membrane (12) is below the cooling water level.

The membrane (12) is connected with the lower surface of the cantilever truss 93) using the heat resistance elements (13) connected with each other by welding with formation of contact gap (14) for providing membrane (12) damage in conditions of failure of cooling water supply from the top on the corium cake. As shown in FIG. 8-10, a pocket (39) is formed in the junction zone of the membrane (12) and lower surface of the cantilever truss (3) along the upper perimeter, providing the deterioration of heat exchange conditions on the part of the membrane (12) to the water, which if there is thermal protection (15) and thermal protection (6) of the flange 95) of the layered vessel (4), covering the membrane (12) from heat radiation on the part of corium mirror, provide cooling of the membrane (12), but these conditions of aggravated heat exchange cannot provide effective heat removal on vigorous heating by radiant heat flows on the part of the corium mirror on damage of the thermal protections (15 and 6).

The distance from the pocket (39) (from the membrane (12) junction point with the cantilever truss (3)) to the corium mirror depends on the cooling water level, the more this level, the further is the pocket (39) from the heat radiation plane of the corium mirror. Two junction zones of the membrane (12) with the cantilever truss (3) and drum (34) have been executed for reducing overheat and destruction of equipment located below the pocket (39) position.

The first junction zone—the junction zone of the membrane (12) and cantilever truss (3) is turned to the corium mirror and directly heated by radiant heat flows. This junction zone has a pocket (39) for organizing deteriorated heat exchange and has elements (13) of the upper heat resistance, which reduce the heat flows from the membrane (12) junction point with the cantilever truss (3). For this purpose, additional plates (40) are installed between the membrane (12) and cantilever truss (3), welding-on thereof is made only along the perimeter to each other and to the cantilever truss (3). The membrane (12) welded to the additional plate (40) cannot transfer heat to a large area due to the fact that upper contact gaps (14) exist between the membrane (12) and additional plate (40) and cantilever truss (3), which provide heat resistance to heat transfer to the thick walled cantilever truss (3) (the cantilever truss is thick walled with respect to the membrane—by capacity to accumulate and redistribute the heat received).

The second junction zone is the junction zone of the membrane (12) and drum (34) turned to the corium mirror and directly heated by radiant heat flows, and the junction zone itself is executed with elements 932) of the lower heat resistance, which reduce the heat flows from the membrane (12) junction point with the drum (34) cover (37). For this purpose between the membrane (12) and the cover (37) additional plates (40) are installed and welding-on thereof is made only along the perimeter to each other and to the cover (37). The membrane (12) welded to the additional plate (40) cannot transfer heat to a large area due to the fact that between the membrane (12) and additional plate (40), between the additional plates (40) themselves as well as between the additional plate (40 and the cover (37), lower contact gaps (33) exist that provide heat resistance to heat transfer to the drum (34), on the outside cooled with water as the layered vessel (4).

The use of elements (13) of the upper heat resistance with upper contact gap (14) and elements (32) of the lower heat resistance with lower contact gap (33) allows reduce the capacity of radiant heat flows for provided controlled fracture of membrane (12), and as a consequence, to reduce the temperature inside the layered corium (4), in this case the scope of failure of thermal protections (15 and 6) is reduced, shape changes of the basic equipment of the corium localizing and cooling system of a nuclear reactor are reduced, and the required margin of safety is provided and reliability is enhanced.

The point of membrane (12) fracture is designed in two levels by design.

The first level—in its upper part at the boundary with the lower plane of the cantilever truss (3) in the area formed above or at the level of the maximum water level position, located around the layered vessel (4) on the outer side, providing gravity cooling water, gas-vapor mixture or vapor input to the inner space of the layered vessel (4) on top on the corium cake in the area closest to the inner surface of the layered vessel (4) on membrane (12) destruction.

The second level—in the lower part of the membrane (12) below the position of the maximum water level located around the layered vessel (4) on the outer side, providing gravity input of cooling water or gas-vapor mixture into the inner space of the layered vessel (4) above the corium cake in the area closest to the inner surface of the layered vessel (4) on membrane (12) destruction.

If the cooling water level is below the maximum level, the membrane (12) is destroyed following heating and deformation. This process takes place simultaneously with the destruction of thermal protection (15) and thermal protection (6) of the flange (5) of the vessel (4), the destruction and melting thereof reduces the shielding of the membrane (12) from the flows on the part of the corium mirror, by increasing the effective area of thermal radiation action on the membrane (12). The heating, deformation and destruction process of the membrane (12) shall develop in the following sequence: in the first stage of membrane (12) overheating the damage shall be from the top to the bottom until the membrane (12) destruction shall not lead to input of cooling water inside the layered vessel (4) to the corium cake, and on insufficient cooling of the membrane (12) on its destruction at the first stage, the membrane (12) destruction process goes to the second stage, wherein the place of joining the membrane (12) and drum (34) is additionally destroyed that shall lead to reciprocal destruction of the membrane (12)— from bottom to top. These two processes provide the water supply inside the layered vessel (4) from the top on the corium cake.

Two conditions must be met for providing the process of membrane (12) destruction only from top to bottom or simultaneously from top to bottom and bottom to top: first is the heat exchange with the external surface of the membrane (12) should deteriorate, otherwise the membrane (12) shall not be destroyed, and the second is it is necessary to have vertically located non-homogeneities, providing the formation of cracks. The first condition is attained by the use of dish membrane (12), for example, semi-circular directed towards the cooling water or gas-vapor mixture, in this case two zones shall be in the deteriorated heat exchange zone: above and below the middle of membrane (12). The application of concave membrane does not give such an effect—the center of membrane (12) is in the area of deteriorated heat exchange that does not allow to heat the fastening area of the membrane (12) to the cantilever truss (3) and to the drum (34) before destruction. The second condition is attained by manufacturing the membrane (12) from vertically oriented sectors (41), connected between themselves by welded joints (42), which provide vertical non-homogeneity, periodically located along the perimeter of the membrane (12), facilitating vertical destruction. The geometrical characteristics of the membrane (12) together with the properties of the main and welding materials used during manufacture allow provide directed vertical destruction of the membrane (12) on action of the radiant heat flows from the corium mirror. As a result, the membrane (12) not only pressurizes the inner space of the layered vessel (4) against uncontrolled inlet of water cooling the outer surface of the layered vessel (4) during normal (standard) water supply to the corium surface, but also protects the layered vessel (4) against overheat during failure of cooling water supply into the layered vessel (4) for the melt.

As shown in FIG. 1, 3, 4, thermal protection (15) is installed inside the layered vessel (4). Thermal protection (15) is suspended to the flange (28) of the cantilever truss (3) using heat-resistant fasteners (19) installed in the heat insulating flange (18) with contact wafer gap (29) located between the heat-insulating flange (18) and flange (28) of the cantilever truss. As shown in FIG. 1, 6, thermal protection (15) is installed such that it overlaps the upper part of thermal protection (6) of the flange (5) of the layered vessel (4), and the circular coffer (16) with pass openings (17) is installed between them in the overlapping area.

As shown in FIG. 3, 4 the thermal protection (15) by design consists of the heat insulating flange (18), connected with the flange of cantilever truss (3) using heat-resistant fasteners (19), outer shell (21), inner shell (24), head (22), vertical ribs (20). The space between the outer shell (21), head (22) and inner shell (24) is filled with melting concrete (26). The melting concrete (26) provides absorption of heat radiation on the part of corium mirror in the entire range of its heating and phase transformation from solid state to liquid. Moreover, the vertical reinforcement rods (23), long radial reinforcement rods (25) and short radial reinforcement rods (27) reinforcing melting concrete are part of the thermal protection (15). The outer shell (21) is executed in such manner that its strength is above the strength of the inner shell (24) and head (22).

As shown in FIG. 6, the circular coffer (16) with orifices (17) provides overlapping of the slit-type gap between the thermal protection (5) of the flange (5) of the layered vessel (4) and thermal protection (15), and forms a kind of gas dynamic damper that allows provide the required pressure drop during the movement of gas-vapor mixture from the inner space of the reactor pressure vessel (2) to the space located outside the thermal protection (15) surface, and reduce the rate of pressure rise in the periphery, simultaneously increasing the rise time of this pressure that provides the required time for levelling pressure inside and outside the layered vessel (4). The fastest movement of the gas-vapor mixture takes place at the time pf destruction of the reactor pressure vessel (2) at the initial stage of corium outflow. The residual pressure in the nuclear pressure vessel (2) acts on the gas mixture located in the layered vessel (4) that leads to the pressure rise on the periphery of the inner space of the layered vessel (4).

Thus, the use of drum, membrane, thermal protection as part of the corium localizing and cooling system of a nuclear reactor allows enhance reliability of the corium localizing and cooling system of a nuclear reactor, efficiency of heat removal from nuclear reactor corium by providing confinement of the layered vessel against flooding by water, input for cooling the outer surface of the layered vessel, independent radial and azimuthal thermal expansions of the cantilever truss and layered vessel during earthquake and impact mechanical actions on the equipment elements of the corium localizing and cooling system, maximum pressure drop during gas-vapor movement from the inner space of the layered vessel to the space located in the area between the layered vessel and cantilever truss.

### SOURCES OF INFORMATION

1. RF Patent No. 2576517, IPC G21C 9/016, priority dated 16 Dec. 2014;
2. RF Patent No. 2576516, IPC G21C 9/016, priority dated 16 Dec. 2014;
3. RF Patent No. 2696612, IPC G21C 9/016, priority dated 26 Dec. 2018.

1. A corium localizing and cooling system of a nuclear reactor containing the guide plate (1) installed under the nuclear reactor pressure vessel (2) and resting upon the cantilever truss (3) installed in the embedded parts in the foundation of the concrete well of the layered vessel (4) designed for intake and distribution of corium, flange (5) thereof is provided with thermal protection (6), filler (7) consisting of several cassettes (8) installed on one another, each of them contains one central and several peripheral orifices (9), water supply valves (10), installed in the branch pipes (11) located along the perimeter of the layered vessel (4) in the area between the upper cassette (8) and the flange (5) characterized in that the drum (34) is installed on the layered vessel (4), executed in shell (35) form with strengthening ribs arranged along its perimeter, resting upon the cover (37) and head (38), having tensioning elements (30) joining the drum (34) through the supporting flange (31) welded to it with the flange (5) of the layered vessel (4), the dish membrane (12) is installed on the drum (34), the convex side thereof is turned outside the limits of the layered vessel (4), in addition, the elements (13) of the upper heat resistance are executed in the upper part of the dish membrane (12) in the joining area with the lower part of the cantilever truss (3), connected to each other by welding with the formation of upper contact gap (14), the elements (32) of the lower heat resistance are executed in the lower part of the dish membrane (12) in the joining area with the drum (34) cover (37), thermal protection (35) is installed in addition inside the layered vessel (4), consisting of the outer (21), inner (24) shells and head (22), suspended to the flange (28) of the cantilever truss (3) by heat-resistant fasteners (19) installed in the heat insulating flange (18) with contact wafer gap (29) located between the heat-insulating flange (18) and flange (28) of the cantilever truss and overlapping the upper part of the thermal protection (6) of the flange (5) of the layered vessel (4), between them the circular coffer (16) is installed in the overlapping area with ports (17), besides the outer shell (21) is executed in such manner that its strength is above the strength of inner shell (24) and head (22), and the space between the outer shell (24) is filled with melting concrete (26) divided into sectors by the vertical ribs (20) and held down by the vertical (23), long radial (25) and short radial (27) reinforcement rods.

2. A corium localizing and cooling system of a nuclear reactor according to item 1 characterized in that between the dish membrane (12) and cantilever truss (3) plates (42) are additionally installed only along the perimeter to each other and to the cantilever truss (3).
